(19) United States
(12) Patent Application Publication
(10) Pub. No.: US 2026/0010822 A1
(43) Pub. Date: Jan. 8, 2026

(54) MODEL MANAGEMENT AND OPERATIONALIZATION TO ACHIEVE REUSABLE MLOPS AND HOT-SWAPPABLE AI MODELS AND SERVICES

(71) Applicant: AT&T Intellectual Property I, L.P., Atlanta, GA (US)

(72) Inventors: Deven Panchal, Middletown, NJ (US); Dan Musgrove, Jackson, NJ (US); Teyu Hsiung, Short Hills, NJ (US); Isilay Baran, Morganville, NJ (US); David H. Lu, Irving, TX (US); Prafulla Verma, Holmdel, NJ (US)

(73) Assignee: AT&T Intellectual Property I, L.P., Atlanta, GA (US)

(21) Appl. No.: 18/765,805

(22) Filed: Jul. 8, 2024

(51) Int. Cl. G06N 20/00

(52) U.S. Cl. CPC G06N 20/00

(57) ABSTRACT

Aspects of the subject disclosure may include, for example, deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. Other embodiments are disclosed.

### FIELD OF THE DISCLOSURE

The subject disclosure relates to model management and operationalization to achieve Reusable MLOps, Reusable Deployment, Reusable Infrastructure and Hot-Swappable AI models and services.

### BACKGROUND

Machine Learning (ML), Deep Learning (DL) and other statistical techniques are being increasingly employed to solve various problems. Over the past few years, there has been an exponential rise in the demand for machine learning expertise in various industries to solve problems that were either not easily solvable or required considerable effort to solve. It is believed that this is due to the rise and availability of ML/DL/Artificial Intelligence (AI) tools, libraries and/or techniques, which has also led to increased popularity of these techniques. This, coupled with the availability of capable training and serving i.e., compute resources like powerful CPU's, GPU's, TPU's and various other offerings in the cloud, has made ML models a solution implemented for many problems.

What remains difficult, particularly for individuals and smaller companies, is the operationalization of these models. While data scientists and machine learning engineers are efficiently performing data cleaning, wrangling, visualization and modeling, it is difficult to architect a working solution complete with the ML model deployed in production, standing as a service, and serving predictions to business applications that may use them. It is also difficult to do model retraining on fresh incoming data, and adjustments of models can result in a significant disturbance to the business applications that are using the model.

One reason why individuals and companies alike face difficulties in model operationalization is because it requires considerable expertise in data engineering, software development, cloud and DevOps. Additionally, it requires planning, agreement, and vision of how the model is going to be used by the business applications once it is operationalized, or in production; how it is going to be continuously trained on fresh incoming data; and how and when a newer model would replace an existing model. This leads to developers and data scientists working in silos and making suboptimal decisions. It also leads to wasted time and wasted manual effort.

Large turnaround times for AI/ML models from experiment stage to production is another problem. The lack of systems and availability of skillsets is likely a cause of this. Integrating AI/ML into applications for which they are meant to provide intelligence has not been shown to be a seamless process. These problems can be further aggravated when different teams need to settle on a common technology stack and end-up having very steep learning curves and wasted time in the process of finally integrating these AI/ML applications with the business applications.

Currently, major providers of cloud offerings e.g., Amazon Web Services (AWS), Azure, and Google Cloud platform (GCP) offer services to AI/ML tasks. This can make it convenient to have ML models. But there is a cost factor associated with this, where cloud providers often charge these APIs by usage, such as requiring a user to pay cost ‘X’ to make ‘Y’ number of calls to the API in a certain time ‘Z’. In addition, there can be charges for underlying infrastructure, storage, and memory usage associated with the AI/ML tasks or services. This cost can become significant once a business application is in production and has a considerable number of users that generate many prediction requests.

Even when operationalizing different models and different versions of the same model in-house, there can be a large cost and time factor associated with it. There are infrastructure and compute costs; manual effort required to set up an ML model training and serving pipeline; and manual effort to write a new microservice.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C is a block diagram illustrating an example, non-limiting embodiment of a system functioning within the communication network of FIG. 1 in accordance with various aspects described herein.

FIG. 2D is a block diagram illustrating an example, non-limiting embodiment of a system functioning within the communication network of FIG. 1 in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for operationalization for models that can include efficient swapping (i.e., replacing) of a model that is in operation; efficient training of other models (which may or may not have: different inputs, different outputs, and/or different types of predictions) while another model is in operation; and changing models in a microservice without breaking down the infrastructure supporting the microservice. Other embodiments are described in the subject disclosure.

In one or more embodiments, operationalization for models utilized in microservices is provided through a model managing platform which expands on machine learning model building that is becoming increasingly accessible, such as due to the availability of numerous tools, libraries and algorithms.

In one or more embodiments, the model managing platform provides for flexibility as to how the model is going to be used by business applications once the model is in production, how the model is going to be continuously or periodically trained on new or fresh incoming data, and how and when a newer model will replace an existing model. In one or more embodiments, the model managing platform avoids developers and data scientists working in silos and making suboptimal decisions, and further avoids wasted time and effort.

In one or more embodiments, the model managing platform can provide for reusable ML Operations (MLOps), where the platform allows for reuse of the existing deployment and infrastructure (e.g., of a microservice) to serve new models by “hot-swapping” them, such as swapping or replacing models without tearing down the infrastructure or the microservice, and/or swapping or replacing models without interrupting the functionality being provided by the microservices (e.g., the functionality can include estimations or predictions being generated in real-time, near-real-time or based on another schedule for outputs according to operational data).

In one or more embodiments, an automatic adjustment can be made for integration of different modules or information that a user has submitted into the model managing platform which includes compiling them together every time that the model changes. In one embodiment, this automatic adjustment can be performed in whole or in part by the model itself. In one embodiment, model driven programming can be utilized to facilitate hot swapping of models and/or to avoid a user needing to rewrite the entire code. In one embodiment, the model itself knows which part(s) to link and which part(s) to remove to form the new ecosystem-based product (i.e., the microservice).

In one or more embodiments, the reusable MLOps can avoid or reduce: infrastructure and compute costs; manual effort required to set up an ML model training and serving pipeline; and manual effort to write a new microservice.

In one or more embodiments, reusable MLOps can reuse the existing deployment and infrastructure to serve new models by hot swapping or replacing them without tearing down the infrastructure or the microservice. In one embodiment, this can be performed utilizing a generic model runner of, or associated with, the model managing platform that performs reusable deployment and operations for AI/ML models (or other types of models) while still having continuously trained AI/ML models in production, all without disturbing the business applications that are using the model.

In one or more embodiments, the model managing platform can be utilized for deployment and operations for AI/ML models (or other types of models) while still having continuously or periodically trained models in production or operation.

In one or more embodiments, the model managing platform can be provided at a limited or no cost to facilitate operationalizing models that an entity's data scientists and ML engineers may have already created in-house (for or by the entity). This is especially useful in avoiding any privacy concerns when dealing with any sensitive data and where ML models are built using the sensitive data.

One or more aspects of the subject disclosure include a device, comprising: a processing system including a processor; and a memory that stores executable instructions that, when executed by the processing system, facilitate performance of operations. The operations include interfacing with a microservice providing functionality to a system of an entity according to operational data, where a first model is operating as part of the microservice and is consuming the operational data; and replacing, via the interfacing, the first model with a second model, where the second model is trained utilizing training data, and where the replacing the first model occurs without interrupting the functionality of the microservice to the system of the entity.

One or more aspects of the subject disclosure include a non-transitory machine-readable medium, comprising executable instructions that, when executed by a processing system including a processor, facilitate performance of operations. The operations include interfacing with a microservice providing functionality to an entity according to operational data, where a first model is operating as part of the microservice and is consuming the operational data; and replacing, via the interfacing, the first model with a second model, where the second model is trained utilizing training data, where the microservice is based on a software stack that includes the first model, and where the replacing the first model is performed while maintaining other elements of the software stack and without bringing the other elements down.

One or more aspects of the subject disclosure are a method including deploying, by a processing system including a processor via a model managing platform, a first model, where the deploying causes the first model to operate as part of a microservice and to consume operational data, and where the microservice provides functionality to an entity according to operational data; accessing, by the processing system, training data; training, by the processing system, a second model utilizing the training data; and replacing, by the processing system, the first model with the second model, wherein the replacing the first model occurs without interrupting the functionality for the entity.

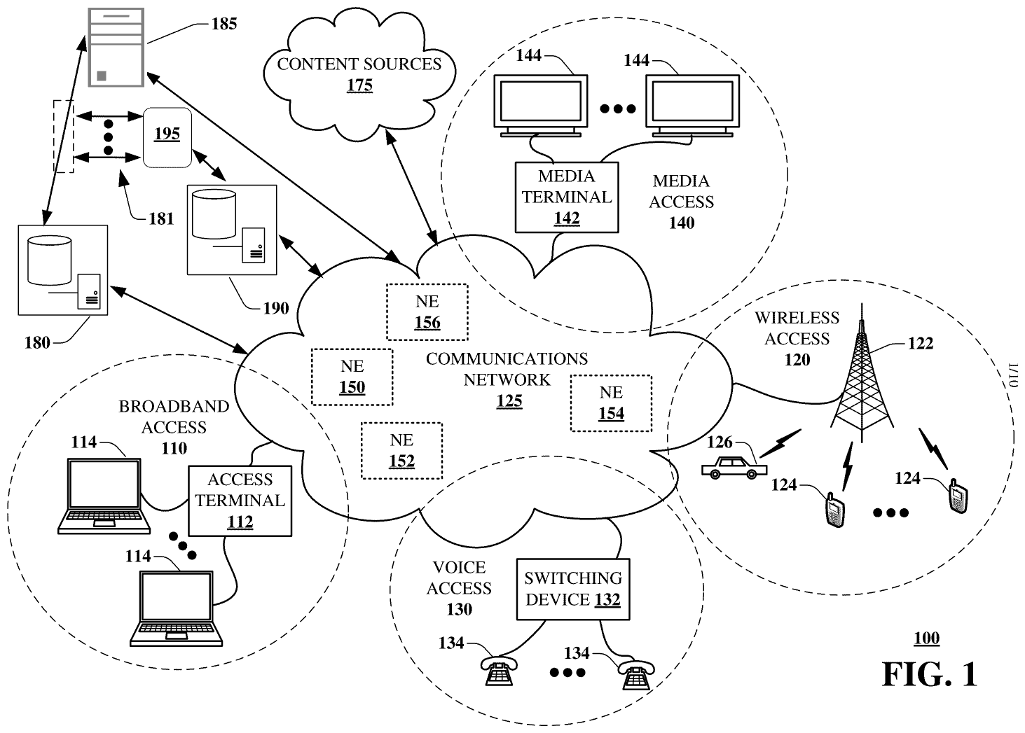

Referring now to FIG. 1, a block diagram is shown illustrating an example, non-limiting embodiment of a system 100 in accordance with various aspects described herein. System 100 can include a model managing platform 180, which can be implemented in various ways including by hardware, software, virtual functions, distributed environments, and so forth.

Platform 180 facilitates operationalization of models, which can include deploying models as a microservice 195 for modeling of targeted systems and replacing deployed models without breaking down the infrastructure of the microservice or without interrupting the modeling of the targeted system. An example of a targeted system 190 is illustrated. It should be understood that the targeted system 190 can be of various types and communications can occur utilizing various techniques and configurations which are represented by the arrows showing communications directly with platform 180 and/or via the network 125. It should be further understood that the systems (e.g., system 190) that utilize the microservice or otherwise have the microservice applied thereto can be of various types including distributed systems with equipment located over various geographic areas, centralized systems where multiple devices are being utilized in a particular area such as a factory or building, and/or a system having integrated components, such as a vehicle.

Platform 180 can be a cost benefit because it avoids costs associated with AI/ML services of cloud providers that are chargeable per API call, as well as any underlying infrastructure, storage, and memory usage. Platform 180 can include, or be associated with, a generic model runner which can facilitate operationalizing models being developed by an entity (e.g., developed in-house) such as in Java, Spark, H2o, and so forth. Platform 180 can further provide security for management and storage of data, the models, and/or the microservices. Platform 180 is applicable to various types of models including Python-based models (e.g., Keras, Scikit Learn, Tensorflow).

In one embodiment, the generic model runner and a Java client can provide a gateway for the models (e.g., AI/ML models) to be provided to, or otherwise entered into, the model managing platform 180. In one embodiment, the use of the generic model runner and the Java client can transform multiple different types of heterogeneous models written by different developers or different teams or different organizations in different languages and frameworks (e.g., Java, Spark, H2o) to become functioning microservices 195 that provide intelligent APIs to the business application associated with the particular system 190 being modeled. As explained herein, a generic wrapper can be applied to the model so that it is usable across various platforms.

The platform 180 can facilitate sharing the models with different individuals and organizations, and can provide for deployment to various cloud targets (e.g., AWS, Azure, GCP, Kubernetes) or downloading and executing on a local machine where the models can be scaled. In one embodiment, these models and microservices 195 can also be chained together using other features in the model managing platform 180 to create modeling or AI pipelines to accomplish more complex tasks.

In one embodiment, the platform 180 provides a GUI interface where models and/or microservices are represented by icons which can be dragged, dropped and connected in that GUI in order to chain them together to create a modeling/microservices pipeline. Other techniques and GUIs can be utilized for enabling the chaining of the models and/or microservices. For example, these created pipelines would now be capable of performing a much more complex analysis using multiple microservices of a system or multiple systems. The platform 180 allows a user or entity to deploy the modeling pipeline to any cloud. In one embodiment, the chaining of microservices can include output(s) of a model(s) or microservice(s) being provided as an input(s) to another model(s) or microservice(s). In one embodiment, the chaining of microservices can include output(s) of a model(s) or microservice(s) being provided to another model(s) or microservice(s) for comparison with other output(s), such as for accuracy.

In one embodiment, the platform 180 allows the models and solutions to also benefit from the platform's federation and licensing features where they can be shared and sold/bought.

In one embodiment, system 100 can provide reusable MLOps, where the existing deployment and infrastructure of an operational model in the microservice 195 can be reused to serve a new model(s) to replace the operational model without tearing down the infrastructure or the microservice. The generic model runner of, or associated with, the platform 180 can be used to achieve reusable deployment and operations for AI/ML models (or other types of models) while still having continuously or periodically trained AI/ML models in production, all without disturbing the business applications (via the microservice) that are using the model. It should be further understood that system 100 allows for different devices to perform different functions in managing the models including the model managing platform 180, a model training platform 185 (which may or may not be operated by the entity controlling the system 190), and/or other devices (or virtual functions). In one embodiment, the model training platform 185 can be equipment of the entity, such as servers and databases, that is used for training models and which may or may not be used to control the entity's system 190.

In one embodiment, API's 181, which are provided or exposed by a running microservice 195, allow an entity or other user to change a model version (described herein as a first model being replaced by a second or replacement model) and/or model behavior on the fly without bringing down the web microservice. In one embodiment, this swapping or replacing of models can be done any number of times at any time period for any number of models. In one or more embodiments, the microservice 195 can expose the APIs 181 for use by various devices including the platform 180, the model training platform 185, other servers of the entity, and/or other computing devices which may or may not be operated by the entity, such as a third-party server that the entity has given permission for accessing the microservice. The APIs 181 can be for various purposes and any number can be provided. For example, one or more of the APIs 181 can be utilized to obtain predictions generated by the microservice 195. As another example, one or more of the APIs 181 can be utilized to provide data or other information that can adjust the model or a new model that is replacing a current model. As another example. one or more of the APIs 181 can be utilized for serializing various files including csv and json files; calculating predictions based on various types of data including csv (or json) data, protofile, and ML model combination; replacing modelconfiguration files; replacing models; and so forth. Access (represented generally by the dashed line rectangle in FIG. 1) to the APIs 181 can be controlled or otherwise dictated in a number of different ways including by the microservice 195, by the platform 180, and/or by the entity that controls the system 190.

In one or more embodiments, while the Java client and the generic model runner has been described for adapting AI/ML models as reusable MLOps, the models may be of various types including models that may not be doing tasks that would involve machine learning or deep learning or AI. For example, system 100 can employ the Java client and generic model runner to adjust financial models like the Black-Scholes option pricing model (e.g., written in Java) or other models in economics, population studies, clinical studies, and so forth in order to create predicting microservices. For instance, the Java client and the generic model runner can provide a toolset to help formalize the process of model driven development even for these types of models, where a user starts by describing the model of the service such as in protobuf (e.g., inputs and outputs of the model). The Java client and the generic model runner can then cause transformation of the service model and code into microservices.

The model managing platform 180 facilitates artificial intelligence accessibility to everyone, and provides efficient techniques for operationalizing AI/ML models quickly and easily. In one or more embodiments, the platform 180 can manage legal requirements with respect to AI/ML enabled IoT applications (or other systems that have privacy/confidentiality concerns) such as related to data sovereignty, data location and data transfer. Federation and licensing provided via the platform 180 can facilitate fine grained sharing of AI/ML models using a model marketplace solution.

Platform 180 can abstract an infrastructure stack and components, and can allow for an out-of-the-box AI environment. Platform 180 also allows complex models written in a variety of languages, using a variety of toolkits, to be efficiently brought to production in microservices. Platform 180 can also enable sharing of models between individuals, teams, departments of the same company, different companies, and so forth. In one embodiment, this sharing of models can be monetized using the licensing and federation features that the model managing platform provides.

In one embodiment, a model runner component of the platform 180 can be used in conjunction with a Java client tool to onboard various models. In one embodiment, the model runner can be used to operationalize a continuously trained model i.e., immediately operationalize a better performing model or seamlessly operationalize a model whose behavior (e.g., inputs and outputs) has changed. In one embodiment, the model managing platform 180 can create zero-touch modeling pipelines for model retraining and model serving, such as through the use of a business environment design platform or software (e.g., Design Studio).

In one embodiment, a model can be trained for a particular type of predictions or estimations with respect to a system. The training can be done in various ways with various tools such as H2o, Java (e.g., any framework/package), Spark, and so forth. Depending upon the package used to create the model, it can then be exported to a file (e.g., Mojo zip file for H2o, jar for Java and Spark) resulting in an exported model file. A Java client tool and a model runner component (e.g., downloadable from the model managing platform 180) can be executed in conjunction with this exported model file. This process would result in the Java client tool generating artifacts (e.g., a proto file, metadata.json and modelpackage.zip) for the model. Also, the model runner can create or otherwise provide a common wrapper (e.g., an Acumos Wrapper) around the model (regardless of the type of model) and can package the model as a microservice, which exposes APIs, such as a number of REST endpoints.

In one embodiment, these artifacts, which can be generated using the Java client tool as described above, can be manually uploaded into a Web GUI of the model managing platform 180 (e.g., for web-based onboarding). In another embodiment, coding/arguments can be passed in when running the Java client tool so that the Java client tool would have done this onboarding including artifacts automatically (e.g., CLI-based onboarding). Once the upload/onboard to the model managing marketplace (of platform 180) is successful, docker images and TOSCA artifacts can be created. These can be deployed from within the model managing platform 180 to a particular target such as Kubernetes, AWS, Azure, GCP, etc.

In one embodiment, the model can be deployed on an entity's own docker enabled cloud/machine because the model managing platform 180 provides for downloading of the docker image(s) directly from the marketplace of the platform 180. The model is now standing as a microservice ready to serve predictions.

In one embodiment, when running in conjunction with a Java client, the generic model runner can have different behavior depending on which type of model it is being used with such as a Java model or a Spark model or H2o model. This can be specified in an application.properties file. In one embodiment, the platform 180 utilizes Protocol Buffers (Protobuf) as a serialization technology due to the large amount of saving, retrieving, and sending of data (e.g., over a network) into and out of the microservices (which the model operates as a part of).

Protobuf provides a language-neutral, platform-neutral, extensible mechanism for serializing structured data. Protobuf can efficiently handle applications where there is a need to serialize structured, record-like, typed data. Protobuf provides the platform 180 with a compact serialized format and has low memory and low network footprints. Protobuf enables a lower latency when communicating with microservices.

In one embodiment, the model runner of platform 180 reads the input proto file, does protobuf compilation using a protoc compiler, and generates a Java Protobuf file. Then the model runner invokes the Java compiler to compile the Java Protobuf file to corresponding class files. These class files are then loaded into the Java Virtual Machine (JVM) dynamically at runtime using the Java classloader. These classes are then used as and when required by the application which is a running spring boot ML model microservice at this point. In one embodiment, not all the classes are loaded into memory together, and can be loaded into memory as and when required. In one embodiment, the port at which the microservice exposes its endpoints is also configurable via the application.properties file.

In one or more embodiments, the microservice is provided with a number of APIs that enable or otherwise facilitate the functionality that is described herein including hot swapping or replacing of a model without breaking down the software stack and infrastructure. The model runner as described herein facilitates setting up the APIs for the microservice.

Table I shows example APIs that can be exposed by the microservice:

| Inputs | Function | Returns |
|---|---|---|
| csv data, proto | Serializes the csv file based on the .proto file | serialized csv |
| file | provided here. The .proto file will not replace | |
| | the default .protofile | |
| csv data | Serializes the csv file based on default.proto file. | serialized csv |
| json data file, | Serializes the json file based on the .proto file | serialized json |
| proto file | provided here. The .proto file will not replace | |
| | the default .protofile | |
| json data | Serializes the json file based on default.proto | serialized json |
| | file. | |
| ML model (format | Replaces the model with a new model | — |
| as specified for | | |
| the various types of | | |
| models) | | |
| modelConfig | Replaces the current modelConfig file used by | — |
| file | Java based models | |
| proto file | Replaces the default .protofile with the supplied | — |
| | .protofile | |
| csv data, proto | Calculates predictions for the csv data, .protofile | serialized |
| file, ML model | and ML model combination | predictions |
| csv data | Calculates predictions for the csv data, for the | serialized |
| | default .protofile and default i.e. current model | predictions |
| json data, proto | Calculates predictions for the json data, | serialized |
| file, ML model | .protofile and ML model combination | predictions |
| json data file | Calculates predictions for the json data, for the | serialized |
| | default .protofile and default i.e. current model | predictions |

The APIs of Table I are an example and other APIs can also be utilized. The model runner of platform 180 can structure or otherwise generate the software stack of the microservice with APIs 181 which include an endpoint to achieve reusable infrastructure such as deployment and operations (i.e., serving) for models while still having continuously/periodically trained models being created or adjusted. This particular API of the microservice allows hot swapping of models so that one model can be running as part of the microservice while one or more other models are being trained (e.g., by a model training server) including based on new data.

As an example, once the model training is complete resulting in a newer version of the current model (e.g., trained on newer data) or resulting in a model having different behavior (e.g., making different predictions associated with different subject matter), a call can be made to a particular endpoint to replace the current model with the new model. When the call returns, the new model has been productionalized (e.g., is operational in the microservice). As described herein, the new model could be a newer version of the previous model, a better performing model, a model making different predictions, and so forth. In one embodiment, the platform 180 can save and version the model jars and other artifacts as well as the docker (microservice) images in protected and securely accessed artifact and image repositories.

In one embodiment, the current model of a microservice can be replaced with a differently behaving newer model which can have different inputs and/or different outputs and/or behaves differently compared to the current operationalized model.

In one or more embodiments, the microservice can provide different endpoints that allow changing or adjusting behavior by replacing a current model with a new model on the fly without bringing down the microservice, and by calling an endpoint which allows passing a proto file, the new ML model, and a sample csv that shows what the test or training data looks like. In this example, this changes the behavior of the microservice, so that it can now answer business questions based on the new ML model-this means that the new ML model is now in production. One could then, for example call an endpoint with a csv file of test data to get predictions off the standing microservice.

In another embodiment, if the inputs and/or outputs of the model have changed slightly, one can upload a new proto file at a/proto endpoint. As described herein, if the new model has changed its behavior, then one can replace the ML model, for example, that predicts failures in a 5G mobility network with a new model that predicts what might be the root cause of a known/observed failure.

In one embodiment, when it is determined that an operational model is not needed, then the standing (operational) microservice and all (or most of) the resources (e.g., associated with the software stack or portions thereof) associated with it can be repurposed and reused for a new model that is substantially different or has limited or little relationship with the current model. As an example, consider a case where a determination is made that a current ML model (e.g., a model that predicts root cause of failure in a 5G mobility network) is not needed. The microservice, which that ML model is operating as a part of, can be repurposed and reused along with resources that have been spent (e.g., compute, time, manual effort) to serve a completely different model (e.g., a model that identifies anomalous IoT devices; a model that estimates the quality of transmission (QoT) for Optical routing inside Software Defined Optical Networks; or a model that predicts which customers will churn this month). These models are different in predictions as compared to the current model in operation. But with the functionality provided by the model runner of platform 180, a hot swap can be performed of the current model with a completely different ML model without bringing down the microservice itself.

System 100 can facilitate in whole or in part deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. In one embodiment, the microservice can be based on a software stack that includes the first model, where the replacing the first model is performed while maintaining other elements of the software stack and without bringing the other elements down, and where the replacing the first model is via APIs exposed by the microservice. In one embodiment, the second model is trained utilizing the training data, at least in part, while the first model is operating as part of the microservice.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

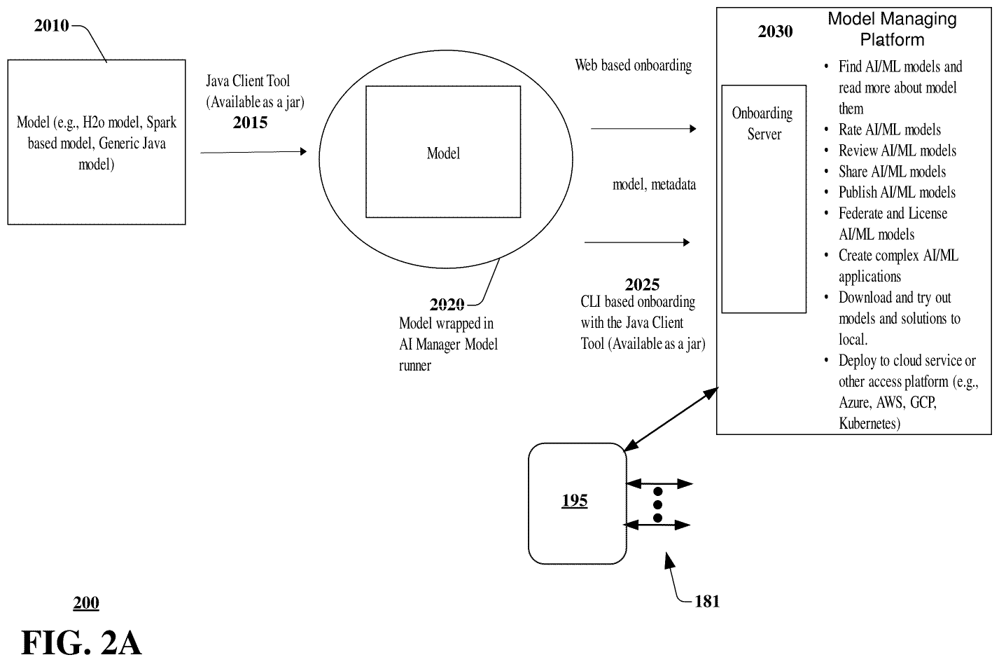

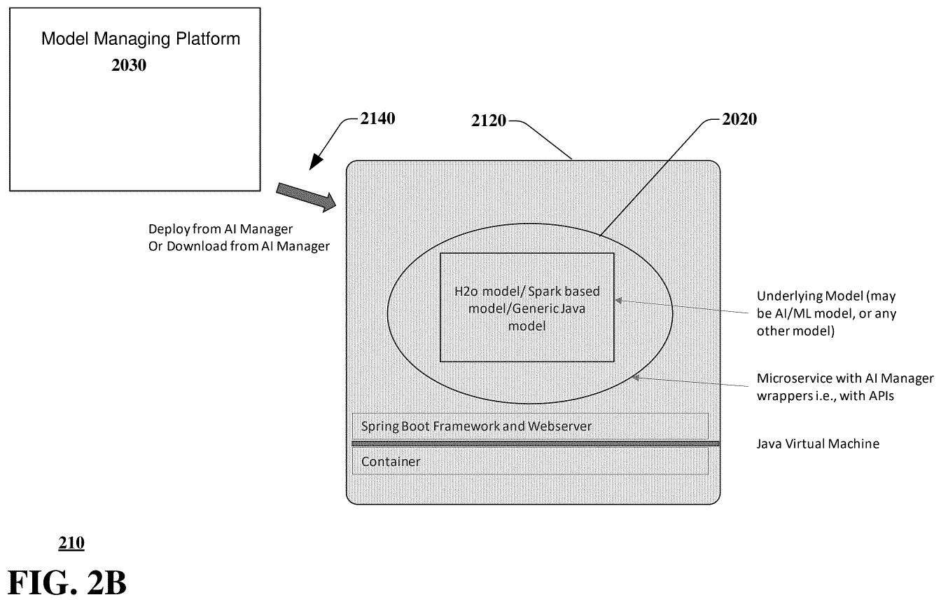

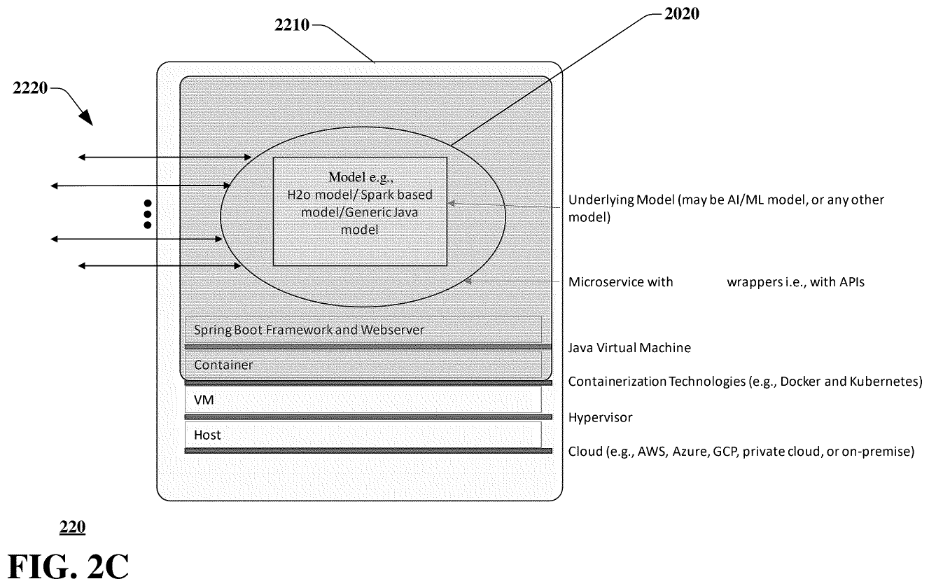

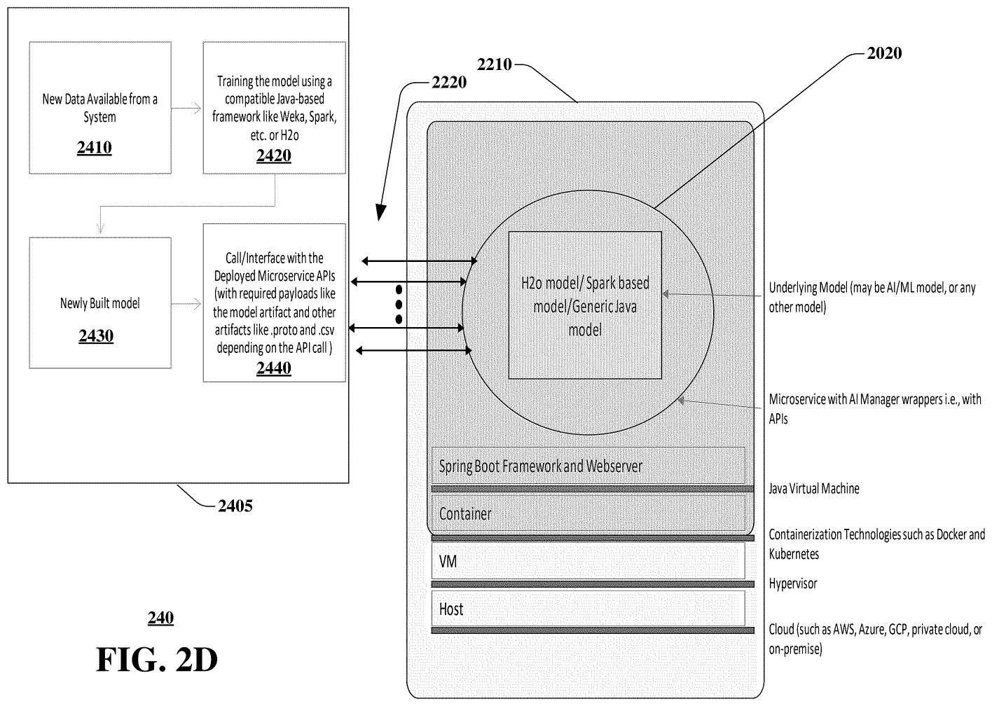

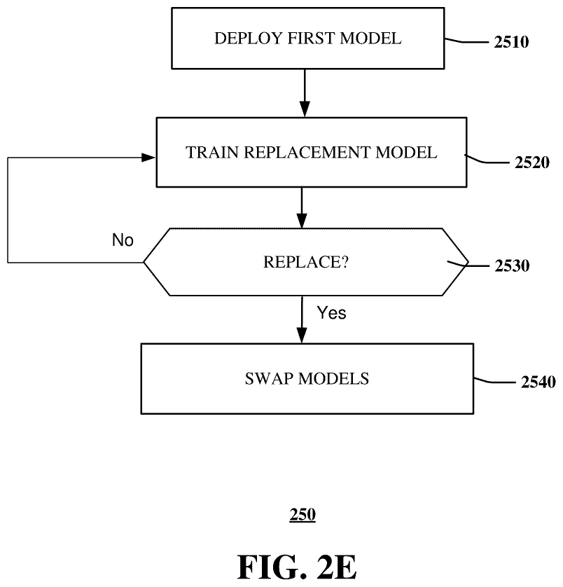

FIG. 2A is a block diagram illustrating an example, non-limiting embodiment of a system 200 functioning within the communication network of FIG. 1 in accordance with various aspects described herein. System 200 illustrates an onboarding of a model 2010 to a model managing platform 2030 (which in one or more embodiments can operate similar to the platform 180 of FIG. 1). In one embodiment, a Java client tool at 2015 can be utilized with the model 2010 to provide a wrapped model 2020. In one embodiment, this can be done utilizing a model runner. The wrapped model 2020 can be onboarded at 2025 to the model managing platform 2030. The platform 2030 enables deploying of the microservice 195 which includes APIs 181 and which utilizes the model 2010.

In one embodiment, the generic model runner and the Java client tool (e.g., written in Java's SpringBoot framework) can be utilized for models (e.g., Java based AI/ML models (Weka, Spark, etc. frameworks) and even H2o framework).

As an example, when using these tools, a user (e.g., data scientists, ML engineers, etc.) would perform data curation, data cleaning, data processing and visualization and then would build a model (e.g., an ML/DL model in H2o, Java, Spark, Python, R, ONNX, or others). The user would then export the model such as to a mojo zip file format (e.g., for H2o) or a jar file (e.g., for Java or Spark). The user can then download the latest version of the Java client artifact from a repository of the platform 180 and also download the latest version of the model runner artifact from the repository. The user would run the Java client tool along with supplying the exported model and the downloaded model runner artifact in order to output particular artifacts (e.g., metadata.json, .proto file, and a modelpackage.zip file). This process can also create a common model manager wrapper around the model and can package the model as a microservice that exposes certain APIs.

At 2025, the user can manually upload the artifacts to the model managing platform marketplace GUI/website (i.e., web-based onboarding) or can employ automated onboarding when running the Java client tool (i.e., CLI-based onboarding).

These onboarding processes can utilize a REST API that the onboarding server exposes to create and onboard the microservice. Once the onboarding of the model to the model managing platform marketplace is complete, the model microservice can then be shared, published to the entity's marketplace, published to the public marketplace, federated to a different organization, exported and deployed to any cloud environment, and/or run locally as a single docker container on a local machine.

FIG. 2B is a block diagram illustrating an example, non-limiting embodiment of a system 210 functioning within the communication network of FIG. 1 in accordance with various aspects described herein and which can function in conjunction with system 200. System 210 illustrates a download or deployment from model managing platform 2030 of a packaged microservice artifact.

In one or more embodiments, the models or microservices are now first class citizens in the model managing platform 2030 (which operates as a modeling marketplace) and benefit from such status. These models or microservices can be shared with different individuals and organizations, and deployed such as to a cloud target, or executed on a local machine, which allows for scaling. These models or microservices can also be chained together using other features in the model managing platform 2030 to create modeling pipelines to accomplish more complex tasks. These models and microservices can also benefit from federation and licensing capabilities of the platform 2030.

FIG. 2C is a block diagram illustrating an example, non-limiting embodiment of a system 220 functioning within the communication network of FIG. 1 in accordance with various aspects described herein and which can function in conjunction with systems 200 and 210. System 210 illustrates a computing stack 2210 for the deployed microservice, along with APIs 2220 (which in one or more embodiments can operate similar to the APIs 181 of FIG. 1) that the microservice exposes. In one or more embodiments as described herein, when hot swapping the underlying model or implementing a reusable MLOPs, only the underlying model changes, while everything else in the software stack 2210 remains as it is—without the need of bringing the software stack down. This saves manual effort and development time because no new microservices need to be developed, and no new effort needs to be spent for writing deployment scripts. The APIs 2220 exposed by the deployed microservice can help users or business applications obtain predictions from the trained model or microservice. The APIs 2220 can also allow for hot swapping of the underlying model and achieving Reusable MLOPs.

FIG. 2D is a block diagram illustrating an example, non-limiting embodiment of a system 240 functioning within the communication network of FIG. 1 in accordance with various aspects described herein and which can function in conjunction with systems 200, 210 and 220. System 240 illustrates an automated and continuous training and deployment of new models. This can be done according to various factors and timing, including manually triggered, initiated on a set cadence, or initiated on a trigger such as an availability of new data. In one or more embodiments, the microservice allows a user to change the microservice configuration on the fly and also allows the user to replace or change the current model (including replacing or changing the model effectively making it a microservice that makes significantly different predictions) all without bringing down the service or the underlying infrastructure.

System 240 includes equipment 2405 that performs a number of functions with respect to the microservice (illustrated as software stack 2210). These functions can be performed via the APIs 2220 that are exposed by the microservice. It should be understood that equipment 2405 can represent any device or combination of devices, including one or more devices of the entity operating the system 190 of FIG. 1, one or more devices that provide the model managing platforms 180, 2030 of FIGS. 1 and 2B, or other devices that are intended to interface with the microservice.

At 2410, data can become available for training of a model and at 2420 the training can be performed. Once the model training is complete, a newer version of the current model (e.g., by applying training to a copy of the model that is stored by the platform 180, 2030) or a different model (e.g., having different behavior and/or different outputs) can be created at 2430. At 2440, the current model can be replaced, such as by calling the ‘/model’ endpoint to replace the current model with the new model. When the call returns, the new model has been operationalized.

FIG. 2E depicts an illustrative embodiment of a method 250 in accordance with various aspects described herein. Method 250 (including some or all of the steps illustrated in FIG. 2E) can be performed by various devices and various combinations of devices, including the devices described with respect to FIGS. 1 and 2A-2D, as well as other user equipment, server(s) operating for model training, server(s) operating for model managing, other computing devices, virtual functions, and so forth. In one or more embodiments, the modeling can be implemented or otherwise provided as a microservice(s) to an entity that is operating a system or process for which operational data can be collected and analyzed by the microservice. One example is a telecommunications network that utilizes microservices for modeling operations and estimating or predicting conditions. However, the exemplary embodiments can be applied to various types of systems utilizing various types of processes and equipment in order to apply models to operational data of the systems, including manufacturing systems, financial technology systems, and so forth. It should be further understood that the systems that utilize the microservice or otherwise have the microservice applied thereto can be of various types.

At 2510, a first model can be deployed. This can be done in a number of different ways including utilizing a model managing platform as described herein. The deployment of the first model can cause or otherwise facilitate the first model operating as part of a microservice. In one embodiment, the first model can consume or otherwise analyze operational data. For example, the microservice can provide functionality (e.g., predictions, estimations, real-time analytics, and so forth) to equipment of an entity according to the operational data.

At 2520, a replacement model (e.g., a second model) can be trained. For example, the training can be performed utilizing newly acquired data (e.g., data obtained after the first model was trained or data obtained after the first model was deployed), previously acquired data (which may include data that was utilized for training the first model) or a combination thereof. In one embodiment, the training data can be obtained from a same source(s) that provided training data used for training the first model. In another embodiment, the training data utilized for training the second model can be obtained from a different source(s) that provided training data used for training the first model. In another embodiment, the training data for the second model can include same and different source(s) that provided training data used for training the first model. In one embodiment, training of the second model can be commenced and completed while the first model is in operation as part of the microservice. However, other timing can be utilized for model training, such as training a number of models at the same time that the first model is trained, or continuing training of other models after the first model training is complete.

At 2530, a determination can be made as to whether the first model is to be replaced. If the model is not to be replaced then method 250 can return to model training at 2520. For example, this can include archiving or storing the trained second model described above and can result in a third model being trained (as described above according to various training data which may be newly acquired or newly accessed data). In one embodiment, the return to model training can include retraining of the second model according to the newly acquired or newly accessed data. In other embodiment, model training can be managed in other ways including training individual models for specified time periods or until specific thresholds are met (such as accuracy) and then commencing training of a new replacement model. Any number of replacement models can be trained in series, in parallel, or a combination thereof.

The particular factor(s) utilized for the determination as to whether the first model is to be replaced can vary. For example, obtaining new training data (e.g., over a threshold amount of data or satisfying a threshold time period of data collection) can be a trigger for replacing the first model. Other factors can include a change in performance of the model (e.g., a decrease in accuracy below a particular threshold), a change in a type or values of the operational data being consumed by the first model, a change in operation and/or equipment of the system that produces the operational data, and so forth. The determination as to whether the first model is to be replaced can be an automated decision (e.g., one or more thresholds being satisfied), a manual decision (e.g., an operations team believing that a replacement of system equipment warrants a model replacement such as a second model that has been trained on data associated with the new equipment), or a combination thereof such as a model replacement recommendation being generated automatically based on a threshold(s) being satisfied (or being violated depending on the type of threshold) which can then be reviewed and approved by the operations team.

At 2540, the first model can be replaced with the second model. The swapping or replacing of a model can be performed as a “hot swap.” As an example, the replacing the first model can occur without interrupting the functionality for the entity. In one embodiment, the microservice can be based on a software stack that includes the first model, where the replacing the first model is performed while maintaining other elements of the software stack and without bringing the other elements down.

In one embodiment, the replacing the first model is via APIs exposed by the microservice. In one embodiment, equipment of an entity or other user associated with the system to which the microservice is providing functionality, can access a model manager such as model managing platform 180, 2030 which can operate as a platform for managing various types of models including AI/ML models. As described herein, this management can include creating complex AI/ML applications, downloading and testing models, deploying models to the cloud, replacing deployed models, and so forth.

In one embodiment, the first model can provide one or more predictions which are for different subject matter as compared to one or more second predictions of the second model. In one embodiment, some or all of the predictions of the first and second models can be of a same type of subject matter. In one embodiment, the first model and the second model can have at least one different input and at least one different output. In one embodiment, some or all of the inputs and/or outputs of the first and second models can be of a same type of subject matter.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

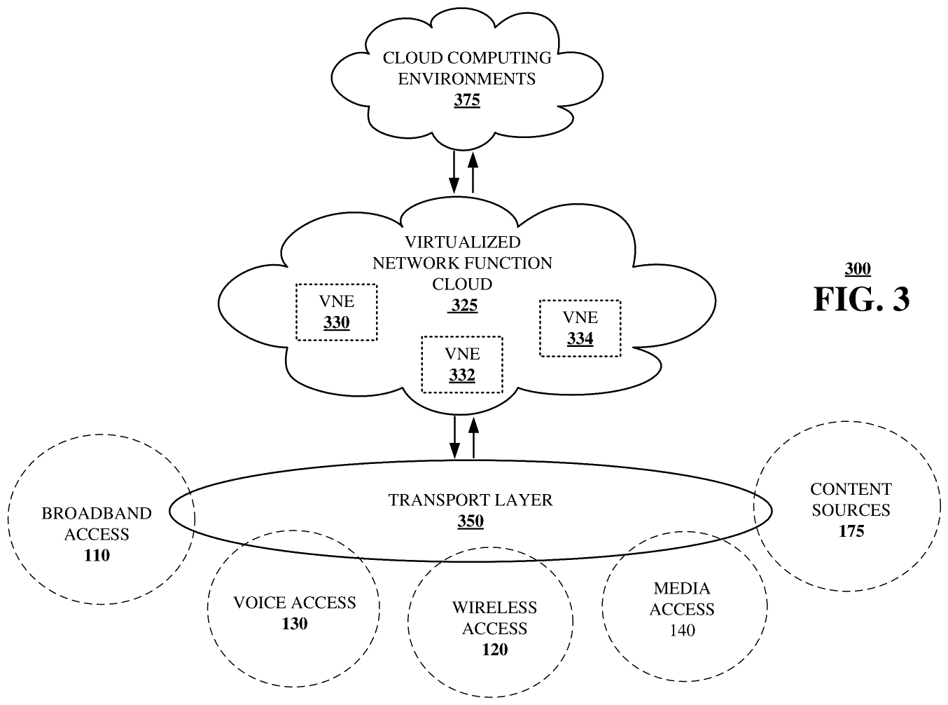

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of the systems and method presented in FIGS. 1, 2A, 2B, 2C, 2D, 2E and 3. For example, virtualized communication network 300 can facilitate in whole or in part deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. In one embodiment, the microservice can be based on a software stack that includes the first model, where the replacing the first model is performed while maintaining other elements of the software stack and without bringing the other elements down, and where the replacing the first model is via APIs exposed by the microservice. In one embodiment, the second model is trained utilizing the training data, at least in part, while the first model is operating as part of the microservice.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

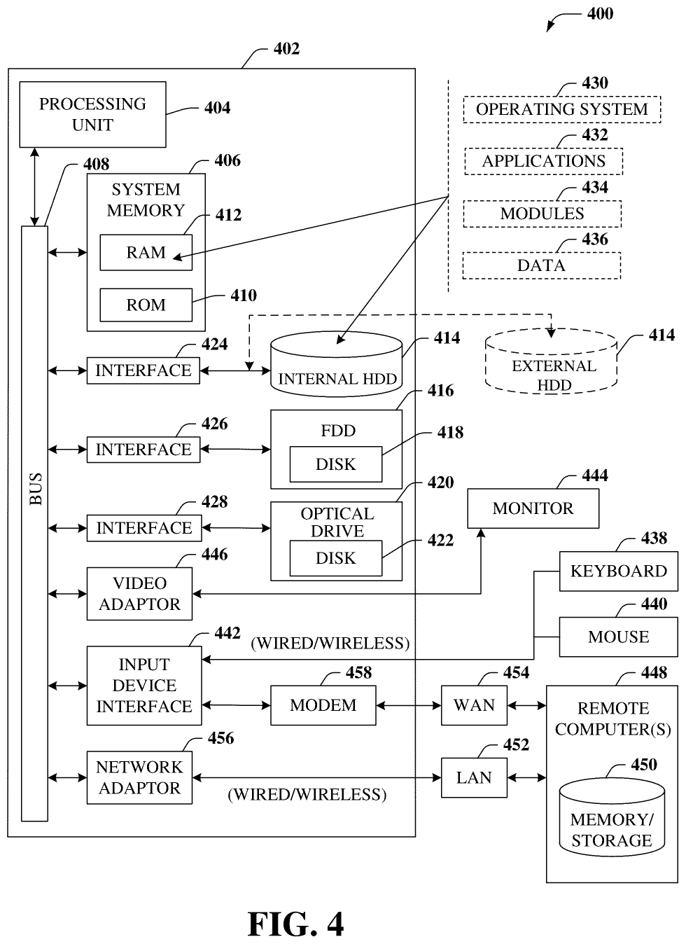

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. In one embodiment, the microservice can be based on a software stack that includes the first model, where the replacing the first model is performed while maintaining other elements of the software stack and without bringing the other elements down, and where the replacing the first model is via APIs exposed by the microservice. In one embodiment, the second model is trained utilizing the training data, at least in part, while the first model is operating as part of the microservice.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

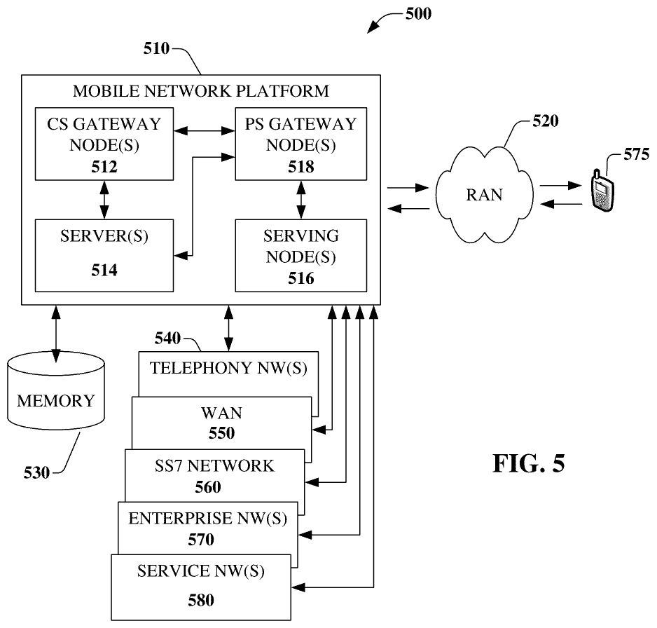

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. In one embodiment, the microservice can be based on a software stack that includes the first model, where the replacing the first model is performed while maintaining other elements of the software stack and without bringing the other elements down, and where the replacing the first model is via APIs exposed by the microservice. In one embodiment, the second model is trained utilizing the training data, at least in part, while the first model is operating as part of the microservice.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

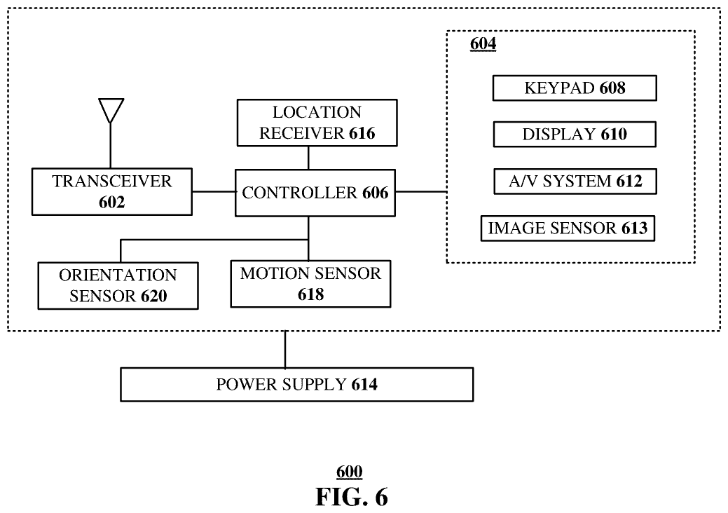

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part deploying, via a model managing platform, a first model, where the deploying causes the first model to operate as part of a microservice and to consume operational data, and where the microservice provides functionality to an entity according to operational data; accessing training data; training a second model utilizing the training data; and replacing the first model with the second model, where the replacing the first model occurs without interrupting the functionality for the entity. In one embodiment, the microservice can be based on a software stack that includes the first model, where the replacing the first model is performed while maintaining other elements of the software stack and without bringing the other elements down, and where the replacing the first model is via APIs exposed by the microservice. In one embodiment, the second model is trained utilizing the training data, at least in part, while the first model is operating as part of the microservice.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit clements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
interfacing with a microservice providing functionality to a system of an entity according to operational data, wherein a first model is operating as part of the microservice and is consuming the operational data; and
replacing, via the interfacing, the first model with a second model, wherein the second model is trained utilizing training data, and wherein the replacing the first model occurs without interrupting the functionality of the microservice to the system of the entity.

2. The device of claim 1, wherein the microservice is based on a software stack that includes the first model, wherein the replacing the first model is performed while maintaining other elements of the software stack and without bringing the other elements down, and wherein information associated with the first model is stored to facilitate reusing the first model in the microservice or in another microservice.

3. The device of claim 1, wherein the first and second models are ML models, wherein the interfacing with the microservice is via a plurality of APIs, wherein the entity is a communications service provider, and wherein the second model is trained utilizing the training data while the first model is operating as part of the microservice.

4. The device of claim 1, wherein the interfacing includes providing the microservice with at least one of a.proto artifact or a CSV artifact via an API call.

5. The device of claim 1, wherein the operations further comprise storing a model JAR and artifacts of the first and second models.

6. The device of claim 1, wherein the operations further comprise storing a docket image of the microservice.

7. The device of claim 1, wherein the first model provides a first prediction, and wherein the second model provides a second prediction which is of a different subject matter than the first prediction.

8. The device of claim 7, wherein the first model and the second model have at least one different input and at least one different output.

9. The device of claim 1, wherein the operations further comprise:
subsequently interfacing with the microservice while the second model is operating as part of the microservice and is consuming the operational data; and
subsequently replacing, via the subsequently interfacing, the second model with a retrained first model, wherein the first model is retrained utilizing other data resulting in the retrained first model, and wherein the subsequently replacing the second model occurs without interrupting the functionality of the microservice to the system of the entity.

10. The device of claim 9, wherein the first model is retrained utilizing the training data while the second model is operating as part of the microservice, and wherein the other data includes at least a portion of the training data.

11. A non-transitory machine-readable medium, comprising executable instructions that, when executed by a processing system including a processor, facilitate performance of operations, the operations comprising:
interfacing with a microservice providing functionality to an entity according to operational data, wherein a first model is operating as part of the microservice and is consuming the operational data; and
replacing, via the interfacing, the first model with a second model, wherein the second model is trained utilizing training data, wherein the microservice is based on a software stack that includes the first model, and wherein the replacing the first model is performed while maintaining other elements of the software stack and without bringing the other elements down.

12. The non-transitory machine-readable medium of claim 11, wherein the replacing the first model occurs without interrupting the functionality for the entity.

13. The non-transitory machine-readable medium of claim 11, wherein the operations further comprise storing a model JAR and artifacts of the first and second models.

14. The non-transitory machine-readable medium of claim 11, wherein the operations further comprise storing a docket image of the microservice.

15. The non-transitory machine-readable medium of claim 11, wherein the first model provides a first prediction, wherein the second model provides a second prediction which is of a different subject matter than the first prediction.

16. The non-transitory machine-readable medium of claim 15, wherein the first model and the second model have at least one different input and at least one different output.

17. A method, comprising:
deploying, by a processing system including a processor via a model managing platform, a first model, wherein the deploying causes the first model to operate as part of a microservice and to consume operational data, and wherein the microservice provides functionality to an entity according to operational data;
accessing, by the processing system, training data;
training, by the processing system, a second model utilizing the training data; and
replacing, by the processing system, the first model with the second model, wherein the replacing the first model occurs without interrupting the functionality for the entity.

18. The method of claim 17, wherein the microservice is based on a software stack that includes the first model, wherein the replacing the first model is performed while maintaining other elements of the software stack and without bringing the other elements down, wherein the replacing the first model is via APIs exposed by the microservice, and wherein the second model is trained utilizing the training data while the first model is operating as part of the microservice.

19. The method of claim 17, wherein the first model provides a first prediction, wherein the second model provides a second prediction which is of a different subject matter than the first prediction.

20. The method of claim 17, wherein the replacing the first model with the second model is via the model managing platform, wherein the first model and the second model have at least one different input and at least one different output.
